(19) United States
(12) Patent Application Publication
(10) Pub. No.: US 2023/0024860 A1
(43) Pub. Date: Jan. 26, 2023

(54) SYSTEMS AND METHODS FOR ILLUMINATING AND DESIGNATING OBJECTS THROUGH USE OF AN ADVANCED PHOTON EMITTER

(71) Applicant: Michael David Aaskov, Kennebunkport, ME (US)

(72) Inventor: Michael David Aaskov, Kennebunkport, ME (US)

(21) Appl. No.: 17/867,654

(22) Filed: Jul. 18, 2022

Related U.S. Application Data
(60) Provisional application No. 63/224,022, filed on Jul. 21, 2021.

(51) Int. Cl. G02B 23/16

(52) U.S. Cl. CPC G02B 23/16

(57) ABSTRACT

A system, device and method are provided with a uniquely self-contained and ergonomic design for facilitating improved target illumination, particularly of objects (including targets and aimpoints for employment of weapons) in low-light conditions, through employment of a weapon-mounted photon-emitting device that houses an easily interchangeable plurality of separate photon emitters in a single package.

This application claims the benefit of U.S. Provisional Patent Application No. 63/224,022, entitled “Systems And Methods For Illuminating And Designating Objects Through Use Of An Advanced Photon Emitter” by Michael Aaskov, filed in the U.S. Patent and Trademark Office on Jul. 21, 2021, the disclosures of which is hereby incorporated by reference herein in their entirety.

### BACKGROUND

### 1. Field of the Disclosed Embodiments

This disclosure relates to systems, devices and methods for facilitating improved target illumination, particularly of objects (including targets and aimpoints for employment of weapons) in low-light conditions, through employment of unique weapon-mounted light-emitting devices.

### 2. Related Art

In general, the terms “illuminator” and “illumination tools,” as used throughout this disclosure, are intended to refer to a class of systems and devices that may be employed to emit light energy (photons), most often in scenarios that will aid in visual identification and/or designation of objects in low-light conditions for, for example, potential or actual engagement with weapons.

Illuminators are used in many situations to project light energy toward a specified location, particularly in wavelengths of the electro-magnetic spectrum that can be viewed as visible light by the human eye. Illuminators are also used to project light energy in wavelengths that may be invisible to the human eye, but that can be detected, or “seen,” with specialized image-intensification devices. Such image intensification devices may include, for example, what are commonly referred to as Night Vision Goggles (NVGs) and/or Night Observation Devices (NODs). In any of these employment scenarios, the general principle behind the use of illuminators is to project and focus the photons (light energy) in an organized manner to increase visibility to specified area surrounding a particular object or objects using a selectable type of photon-emitting technology.

It is well known to mount illuminators to weapons. In this manner, a weapon-mounted illuminator may serve to increase a weapon user's ability to identify and designate objects for engagement, targets or aimpoints in low-light conditions. The mounting and employment of illuminators may tend to significantly influence the tactics, techniques, and procedures of employing a variety of weapons in low-light conditions.

In basic implementations, an illuminator may include an “emitter” that may be specifically composed of virtually any device that is usable to project photons (light energy in the visible and non-visible spectrum) to a selected area. Technologies for these emitters may include incandescent lighting (bulbs), light-emitting diodes (LED), light-emitting plasma (LEP), light amplification by stimulated emission of radiation (LASER) and other similar illuminating technologies.

Users understand that known illuminators suffer certain shortfalls which heretofore have been dealt with and accepted, often with some level of frustration on the part of the users.

Many available light-emitting devices are large and cumbersome. Power may be supplied to these devices by non-portable, or not easily-transportable, power sources, thereby exacerbating the difficulties with flexibility in transport and employment of such illuminators, particularly in, for example, tactical scenarios. Even in scenarios in which the size of the illuminators are reduced, there remain other shortfalls.

In a most basic implementation, a flashlight, or any other photon-emitter technology may be attached to the weapon and used to illuminate desired objects and/or areas. Generally, the intensity of the emission of photons (light energy) may be locally increased or decreased until visible light levels are adequate to illuminate the desired objects and/or areas.

A current standard, particularly for weapon-mounted illumination, may be typically limited to combination of diffused and/or collimated, high-powered LASERs and/or collimated high-powered LEDs. There are many manufacturers of weapon-mounted illuminators. In a common implementation currently employed by U.S. and other military forces worldwide, a comparatively easily-adaptable illumination device may provided for a variety of different weapon-mounted tasks. The widely-fielded device uses high-powered visible and invisible (infrared) LASERs to produce adequate illumination for short range and extremely long-range target identification and designation.

Even as users and operators employ the array of currently-available weapon-mounted illuminators with reasonable success, all admit that the currently-available illumination tools underperform in one or more of the following primary areas.

Many identify as a shortfall the limitations in the availability of an array of available light wavelength options in a single device. Current devices limit the user to a wavelength of light depending on what illumination device is purchased.

Any attempt to modify or augment a single illuminator today typically requires non-optimal employment a weapon-mounted laser device could be, for example, supplemented in an example handgun employment with use of a hand-held flashlight in the user's or operator's non-dominant (weak) hand. The beam of the flashlight could be trained in the same direction as the beam from the weapon-mounted emitter. Such a scenario is necessarily cumbersome and does not easily lend itself to rifle or other long gun employment. Put more generally, the ergonomics of non-optimally employing multiple emitters, such as by cobbling three separate devices together, may, for example forces the user or operator into undesirable hand positions, adding to shooter fatigue, negatively affecting shooter accuracy and/or adversely affecting safety in employment. Moreover, requiring multiple bodies to house the illuminators and supporting electronics of multiple devices creates redundant geometry thus adding unnecessary complexity, weight and cost.

Adding to the above, should one choose to attempt to sub-optimally employ multiple illumination tools, is the need for potentially supplying multiple batteries (including multiple types/size of batteries) to one's kit creating additionally inefficient and cumbersome power management issues and logistical complexity.

Finally, currently-fielded weapon-mounted illuminators, including the devices generally described above, often require high-powered LASERs to project enough photons to be useful at distances when used with image intensifying devices such as NVGs and/or NODs. Though tremendously effective, many LASER-based devices are not available for sale in the general commercial market in the United States. While non-military and non-governmental individuals are legally permitted to purchase high-powered lasers, there are restrictions in the United States. For example, the United States Food and Drug Administration (FDA) restricts the sale of LASERs with comparatively higher output powers with respect to the wavelength. LASERs in the 850 nm wavelength range, for example, are limited to 0.70 mW for sale in the U.S. commercial market.

### SUMMARY OF DISCLOSED SUBJECT MATTER

As is detailed above, there are many variations of currently-available weapon-mounted illuminators and illumination tools in use, many of which are plagued with one or more of the above catalogued attendant logistics and employment shortcomings.

In view of these and other perceived shortfalls, there is a need for improvements in portable, battery-powered devices, to potentially include multiple emitters, with a recognition that size, weight, design configuration, emitter availability and power supply can be important aspects and design considerations. As an example, it may be preferable that a profile of a multi-emitter illuminator device be small enough that, when the device is weapon-mounted, the device does not add a cumbersome physical appendage to the weapon. Objectives may include that the inclusion of the device would not alter critical employment properties of the weapon system, once the device is mounted, in a manner that would, for example, significantly (1) increase the weight of the weapon system or (2) upset critical balance of the weapon system, in a manner that would lead to added user fatigue or change user employment. Ultimately, users and operators may benefit from a small, low-profile multi-emitter illuminator device to increase the speed and efficiency with which targets and/or aimpoints can be identified, illuminated, designated and engaged, thereby increasing overall safety to the users and operators in employment of weapons augmented with such devices.

In view of the shortfalls in illuminator systems and devices, particularly those that are currently available for purchase in the U.S. commercial marketplace, it may be advantageous to provide a particularly-configured photon (light energy) emitting device that captures the basic benefits of the current weapon-mounted illumination systems, and that provides a simplicity with respect to conventional configurations, but that avoids reliance on the use of restricted, high-powered LASERs that are a mainstay in currently available devices. In embodiments, it may be further advantageous to provide such a device that improves an ergonomic design of the device by, for example, providing a simple, straightforward device that removes features that may increase adjustability, but that may coincidentally increase the complexity of the device.

Exemplary embodiments of the systems and methods according to this disclosure may provide an improved photon-emitting (light energy emitting) illumination device that uniquely takes advantage of available technologies to address the above-described issues and perceived limitations with conventional illuminators and illumination tools, even hi-tech conventional devices.

Exemplary embodiments may replace the conventional high-powered LASER-based illumination system with a new and unique configuration of photon-emitting technologies that include a number of simple user-serviceable and user field modifiable options, particularly with regard to the supporting optics that may be easily changed out, thereby providing safe, adequate illumination without creating a device that is generally subject to the same sorts of restrictions imposed on laser-based illumination systems.

In embodiments, this disclosure is directed to a modular design for an illuminator that may allow use of multiple light wavelengths, as needed. For example, a user or operator may be able to select for emission ultraviolet light at 320 nm from a first emitter (head or aperture), and separately select for emission infrared light at 1000 nm from a second emitter (head or aperture), while also, or alternatively, selecting for emission a laser designator from a third emitter (head or aperture. In embodiments, each of the first, second and third emitters with appropriate power supplies and controls, may be incorporated in a single housing.

Exemplary embodiments may provide a modular architecture that may be based on an asymptotic approach to geometry and geometric construction. In embodiments, such an approach may leverage, for example, 3D printing for fabrication or formation of a body or housing for the disclosed illuminator device. Materials may be employed that may create an electrically conductive unit that results in less material being used in an efficient fabrication process.

Importantly, this disclosure may generally refer to that class of photon (light) emitting devices that are truly portable, and powered by batteries, to increase a range of mobility for employment of the devices.

One beneficial characteristic of embodiments of the disclosed device is that the emissions from one or more of the emitters may be adjustable through a series of diffusers and/or a series of power settings to provide illumination to fit virtually any illumination requirement or employment scenario. Understandably, such adjustability may be a more beneficial advantage to identifying, illuminating and engaging objects and targets at range without rendering the illumination device unnecessarily complex for most “common” employment scenarios that may be encountered within the relatively short ranges of many personal small arms.

In embodiments, use of a modular photon-emitting system may provide an illuminator that is combinable with a restricted or non-restricted LASER to also provide an ability to designate targets on a functional level adequate for a majority of situations or engagement scenarios.

Exemplary embodiments may provide a simple design for an illumination and laser designation device that may be formed or fabricated of a conductive metal body as an electrical ground between one or more battery compartments, and may create one or more circuits by routing one or more insulated wires through one or more internal tunnels passing through the metal grounded body, in order to power the plurality (when present) of photon (light energy) emitting components of the device.

Exemplary embodiments may incorporate one or more mounting screws with outside cylinder diameters that perpendicularly intersect the inside cylinder diameter of one or more battery compartments.

Exemplary embodiments may provide one or more integrated and/or tactile buttons that, when pressed, may activate (turn on) any series of electrical circuits or combinations of electrical circuits for routing battery power one or more of the plurality (when present) of photon (light energy) emitting components of the device.

Exemplary embodiments may provide an improved ergonomic experience when weapon-mounted, as the tactile buttons are positioned to complement the natural position of weapon manipulation and can be ambidextrously activated.

Exemplary embodiments may provide geometry that efficiently houses batteries and photon-emitters in a symmetrical layout with relation to the center bore-axis of the weapon, when mounted, for proper weight and balance and other considerations.

Exemplary embodiments may provide configurations to facilitate the device being powered by a single battery, by multiple batteries of a same type or by multiple batteries of different types.

Exemplary embodiments may place a laser, substantially configured to designate objects, aimpoints or targets, directly over and aligned with a bore of a weapon on which the device may be mounted, and on a same plane as a parabolic gravitational trajectory of the host-weapon's projectile when fired in what may be considered a standard operating orientation.

Exemplary embodiments may provide conductive battery caps with tapered threads so that battery replacement can be completed with greater ease than with non-tapered battery cap threads, and without requiring removal of the device from the weapon to which the device attached.

Exemplary embodiments may provide a series of photon-emitters that can be serviced by the end-user without special tools or capabilities. Servicing in this regard may include, but is not limited to, ambidextrous interchangeability (including potential interoperability with a wide array of available photon-emitters, additional battery extensions, battery replacement, replacement of lenses, filters, covers, collimators, reflectors, or any other common modifiers of the photonic emissions, and the like.

Exemplary embodiments may provide or incorporate combinations of one or more photon emitting technologies that operate across the visible and non-restricted non-visible light spectrums (ranges of wavelengths).

Exemplary embodiments may provide at least one of a conventional or particularly configured mounting accessory or adapter to facilitate removable engagement with a variety of weapons without specific or special additional configuration of the weapons. In embodiments, such mounting accessories or adapters may be usable to cooperate with standard weapon accessory mounting rail temporarily or permanently configured on, or attached to, weapons, including conventional universal, Picatinny/NATO, Weaver, Dovetail or other proprietary rails.

These and other features, and advantages, of the disclosed systems, devices and methods are described in, or apparent from, the following detailed description of various exemplary embodiments.

### BRIEF DESCRIPTION OF THE DRAWINGS

Various exemplary embodiments of the systems, devices and methods for providing a unique illuminator or illumination tool for facilitating improved target illumination, particularly of objects (including targets and aimpoints for employment of weapons) in low-light conditions, through employment of unique weapon-mounted light-emitting or photon-emitting devices, according to this disclosure, will be described, in detail, with reference to the following drawings, in which:

FIG. 1 schematically illustrates a first perspective view of an exemplary embodiment of a weapon mountable photon-emitting device according to this disclosure;

FIG. 2 schematically illustrates a second (partially-exploded) perspective view of an exemplary embodiment of a weapon mountable photon-emitting device according to this disclosure;

FIG. 3 schematically illustrates a first nominally top view of an exemplary embodiment of a weapon mountable photon-emitting device according to this disclosure;

FIG. 4 schematically illustrates a second (partially-exploded) nominally top view of an exemplary embodiment of a weapon mountable photon-emitting device according to this disclosure; and

FIG. 5 schematically illustrates a nominally bottom view of an exemplary embodiment of a weapon mountable photon-emitting device according to this disclosure.

### DETAILED DESCRIPTION OF EMBODIMENTS

The disclosed systems and methods for providing an improved illumination device, particularly one intended to conform to known governmental safety restrictions, and to address known operational shortfalls, through application of a unique design of a multi-emitter portable weapon-mountable illumination device, will generally refer to this specific utility or function for those systems and methods. Exemplary embodiments described and depicted in this disclosure should not be interpreted as being specifically limited to any particular configuration of the described elements, or as being specifically directed to employment in any particular use case, operational employment, or tactical engagement scenario, weapon-mounted or otherwise. Any advantageous combination of the disclosed schemes that may employ a particularly-configured illumination device including some or all of the disclosed features, centered on a plurality of photon-emitting (light energy emitting) devices is contemplated as being encompassed by this disclosure.

Specific reference, for example, to various configurations of a particularly unique ergonomic design of an illumination device should not be considered as limiting the configuration, or the application of the disclosed concepts to any particular limiting configuration of the respectively disclosed components, or necessarily to an illumination device that must include all of the disclosed components. The use of commonly-understood terms for light projection and photon-emitting devices is intended to be inclusive rather than exclusive, as the disclosed terms should be read to broadly encompass systems, devices, schemes and elements that may involve all manner of related illumination and designation applications for emitting visible and non-visible light, as that concept would be understood to those of ordinary skill in the art. This should be considered to apply equally broadly to the disclosed mounting concepts and to other weapon accessory mounting concepts that would be familiar to those of skill in the art.

It will be appreciated that features and advantages of the disclosed embodiments may be set forth in the description which follows, and in part may be obvious from the description, or may be learned by practice of the disclosed embodiments. The features and advantages of the disclosed embodiments may be realized and obtained by means of the instruments and schemes particularly pointed out below. The features of the disclosed embodiments may become more fully apparent from the following detailed description.

Various embodiments of the disclosed devices may be discussed in detail below. While specific implementations may be discussed, it should be understood that this is done for illustration purposes only. A person skilled in the relevant art may recognize that other components and configurations may be used without departing from the spirit and scope of the disclosed embodiments.

Details of the unique features of the disclosed systems and methods will now be described generally with reference to the following detailed figures, which are provided for illustration purposes only, and depict an exemplary configuration of an improved illumination device according to this disclosure.

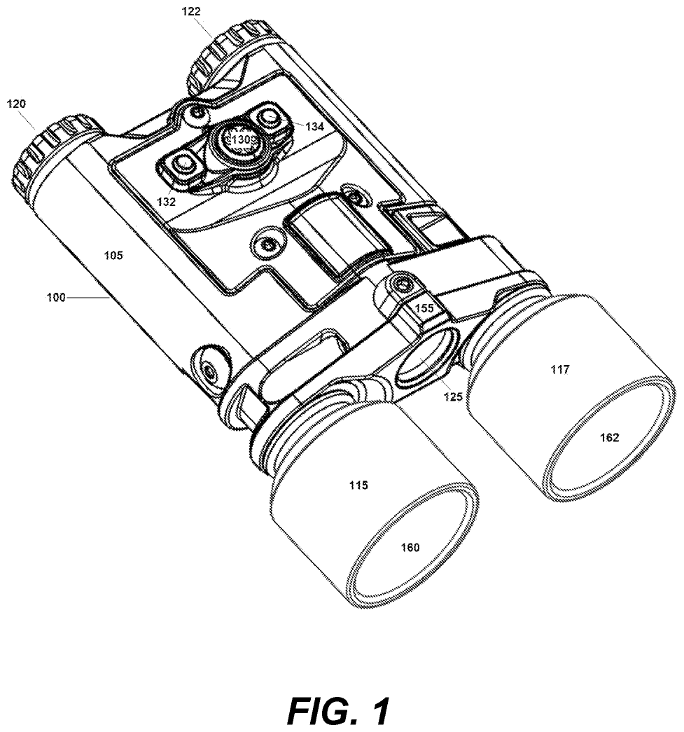

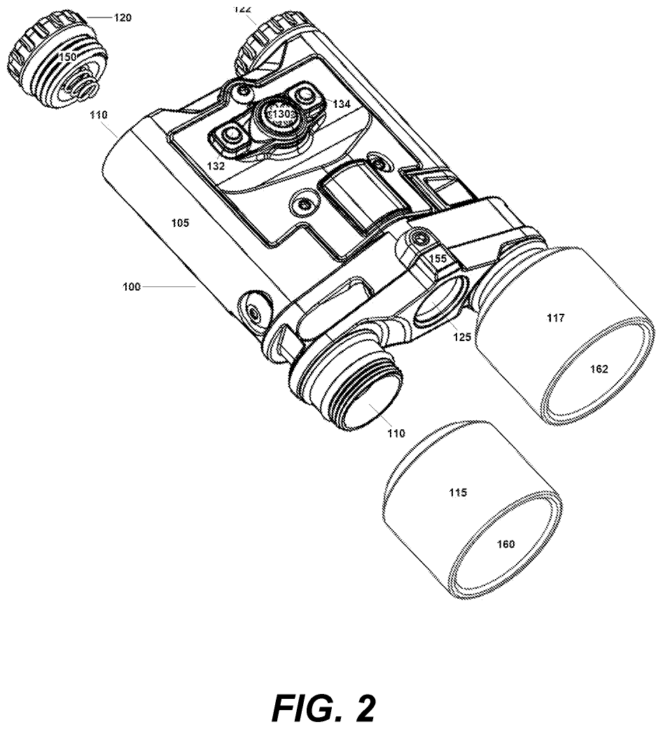

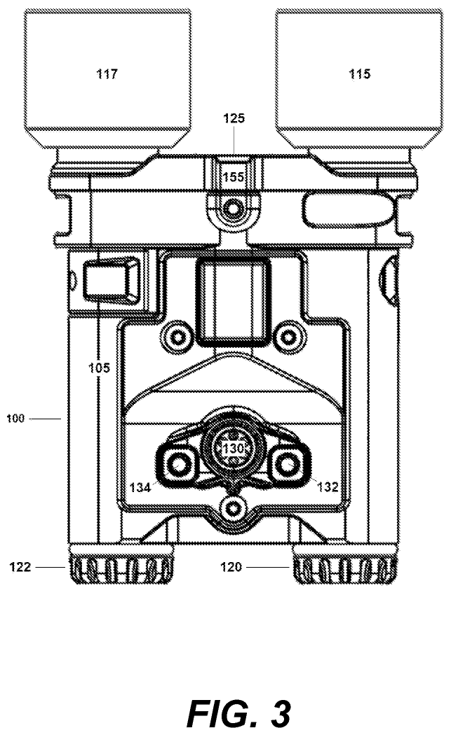

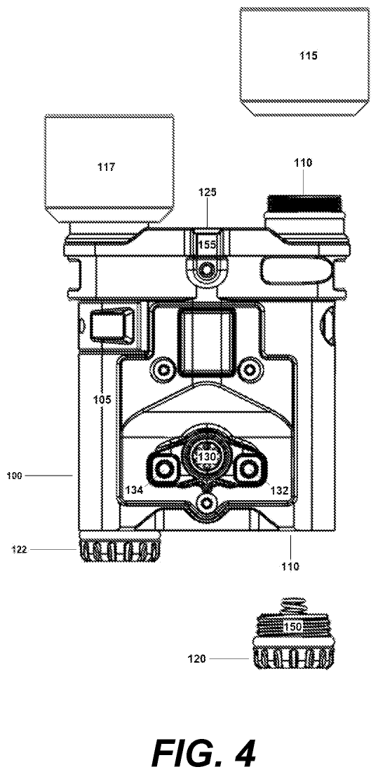

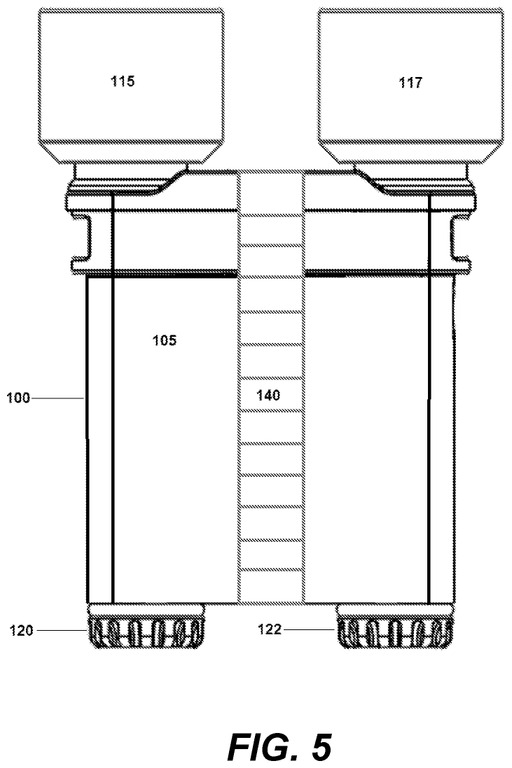

FIG. 1 schematically illustrates a first perspective view of an exemplary embodiment of a weapon mountable photon-emitting device according to this disclosure. FIG. 2 schematically illustrates a second (partially-exploded) perspective view of an exemplary embodiment of a weapon mountable photon-emitting device according to this disclosure. FIG. 3 schematically illustrates a first nominally top view of an exemplary embodiment of a weapon mountable photon-emitting device according to this disclosure. FIG. 4 schematically illustrates a second (partially-exploded) nominally top view of an exemplary embodiment of a weapon mountable photon-emitting device according to this disclosure. FIG. 5 schematically illustrates a nominally bottom view of an exemplary embodiment of a weapon mountable photon-emitting device according to this disclosure.

As shown in varying levels of detail in FIGS. 1-5, a weapon mountable photon-emitting device 100 according to this disclosure may be provided. The device 100 may have a main housing body 105. A plurality of photon emitters 115, 117, 125 may be mounted on or in the main body housing 105. The main housing body 105 may be formed or fabricated of an electrically conductive material. The main housing body 105 may enclose at least one completely through passage 110 (enclosed tunnel, second not shown) that facilitate the routing the mounting of a power source, which may be in a form of a battery, and/or electrical power components and/or wiring that may power one or more of the plurality of photon emitters 115, 117, 125. The enclosed tunnel 110 may be closed at one end with a battery cap 120, 122. The photon emitters 115, 117 in a preferred arrangement may consist of two emitters in a symmetrical arrangement that may be usable to provide general illumination for visually identifying objects including targets, supplemented by a third photon-emitter 125, which may be in a form of a laser, and which may be centrally located to provide a light source that can be precisely used to designate targets. The photon emitters 115, 117 may be selectable and allow use of multiple light wavelengths, including wavelengths of light in the visible and non-visible spectra, as needed. For example, a user or operator may be able to select for emission high intensity visible light from one or the other of the photon emitters 115, 117, or separately ultraviolet light at 320 nm from one of the photon emitters 115, 117, or separately infrared light at 1000 nm from one of the photon emitters 115, 117, while also, or alternatively, selecting for emission a laser designator from the third photon emitter 125.

The main housing body 105 may be formed of any suitable conductive material. Embodiments of the main housing body 105 may be formed according to known manufacturing methods. In embodiments, the main housing body 105 may be formed by means of a subtractive manufacturing process. Subtractive manufacturing, as used in this disclosure, is an umbrella term for various controlled machining and material removal processes that may start with solid blocks, bars, or rods of material. The materials may include, but are not limited to, plastics, metals, and other materials that are shaped by removing material through processes that may include cutting, boring, drilling, and grinding. These processes may be manually operated, and/or may be controlled with Computer Numerical Control (CNC) and similar automated technologies. In alternative embodiments, the main housing body 105 may be formed by means of an additive manufacturing process. For example, the main body housing 105 may be formed from unique application of the technology commercially referred to as a Direct Metal Laser Sintering (DMLS). DMLS may generally be described as additive manufacturing in nature, using a variety of alloys, melted and fused together by a laser. DMLS components are built layer by layer in a pressurized container, thus making it possible to design the components with organic geometries, internal features and challenging passages that could not be cast or otherwise formed or manufactured in conventional subtractive manufacturing methods. Additive manufacturing is ideal for complex parts and assemblies that have multiple components that traditionally would have had to be machined and/or produced separately and welded together, but can now be consolidated into a single piece geometry.

One or more control components may be integrated into the main housing body 105, and may be usable to control emissions from each of the photon emitters 115, 117, 125. In embodiments, the one or more control components may be in a form of tactile activation buttons 130, 132, 134. The tactile activation buttons 130, 132, 134 may be integrated into the main housing body 105. The one or more tactile activation buttons 130, 132, 134 may be usable to activate internal switching mechanisms or circuits that in turn power discreet electrical circuits within the device 100 to, for example, turn the photon emitters 115, 117, 125, on and off, and/or to control an intensity of emissions from one or more of the photon emitters 115, 117, 125. In embodiments, no external electrical switching mechanisms or apparatus may be required to activate the device 100, or the photon emitters 115, 117, 125, but provisions and recesses may be provided to add external electrical wiring as needed, or preferred by the user or operator.

It should be understood that a preferred design may provide an improvement to the ergonomics of the device 100, as shown, when used in conjunction with modern weapons and weapon manipulation techniques. The tactile activation buttons 130, 132, 134 may have a profile with respect to the rest of the device 100, and particularly the main body housing 105 and thus may be easier to locate and to activate/manipulate, even in low ambient light conditions. As shown, the tactile activation buttons 130, 132, 134 may be placed at different heights respectively to the main housing body 105, or to each other, to improve the user's or operator's ability to differentiate between tactile activation buttons 130, 132, 134 without a need to view the device 100. In embodiments, the device 100 may be designed and manufactured to be ambidextrously activated, with the inclusion of redundant tactile activation buttons 132, 134, where appropriate, or tactile activation buttons 130 that may be available particularly to be actuated with either hand. In embodiments, the tactile activation buttons 130, 132, 134 may be usable to adjust or select an intensity of the emission from the photon emitter 115, 117, 125.

Generally, it is intended that the enclosed tunnels (see, e.g., element 110), which may house the batteries and may be capped at proximal ends with battery caps, 120, 122, may be capped at distal ends by one or more of the photon emitters 115, 117, and may be advantageously arranged symmetrically with respect to a centerline of the main housing body 105, which may be intended to align with a center bore axis of a weapon to which the illuminator 100 may be mounted for use. This symmetrical arrangement may make efficient use of negative space that is ubiquitously found on modern weapon platforms. By using the negative space, the device 100 may occupy as little volume on the host weapon as possible.

In embodiments, symmetrical attachment to a weapon may be facilitated by at least one conventional or particularly configured mounting accessory or adapter 140 (see FIG. 5). Note here that although FIGS. 3 and 4 nominally depict a “top” view and FIG. 5 nominally depicts a bottom view, there is no restriction on the device 105 being employed in an inverted condition in which the mounting accessory or adapter 140 may be used to engage the weapon under the barrel thereof. The mounting accessory or adapter 140 may be advantageously configured to facilitate removable engagement with a variety of weapons without specific or special additional configuration of the weapons. In embodiments, the mounting accessory or adapter 140 may be usable to cooperate with standard weapon accessory mounting rails temporarily or permanently configured on, or attached to, weapons. These standard weapon accessory mounting rails may include, but not be limited to, configurations as conventional universal, Picatinny/NATO, Weaver, Dovetail or other proprietary rails.

In embodiments, the battery covers 120, 122 may have a tapered thread geometry that allows for battery replacement to be undertaken with greater ease than with non-tapered battery cap threads (see, e.g., element 150) and without removal of the device 105 from the weapon to which it is attached via the mounting accessory or adapter 140 or otherwise.

Embodiments of the device 100 may have one or more extended battery caps 120, 122, or extended conductive extension tubes (e.g., an extension of element 150) that can house additional batteries and thereby increase the capacity of available output power supplied to the photon-emitters 115, 117.

In embodiments, the third centrally-located photon-emitter 125, which may be in a form of a laser, may have adjustment mechanisms 155 that allow for an emitted laser beam for target designation to be adjusted in two independent planes with respect to the centerline of the main housing body 105, and thus the host weapon's projectile point of impact, when mounted on a host weapon.

In addition to use of the tactile activation buttons 130, 132, 134 to adjust or select an intensity of the emission from the photon emitter 115, 117, an intensity of the emissions from the photon emitters 115, 117 may be modified through the use of one or more inserts 160, 162. The inserts 160, 162 may include, but not be limited to, lenses, filters, covers, collimators, reflectors, or any other common modifiers of the photonic emissions, and the like.

All of the various components of the exemplary device 100, as depicted in FIGS. 1-5, may be connected internally in myriad configurations, and may be connected to various weapons according to the discussion above in upright, inverted and any other angle interplay, as may be supported by the depicted and described mounting accessory or adapter 140, or otherwise.

It should be appreciated that, although depicted in FIGS. 1-5, as an essentially integral unit, various disclosed elements of the exemplary device 100 may be arranged in any combination of sub-systems as individual components or combinations of components, integral to the single unit, or external to, and in wired or wireless communication with the single unit of the exemplary device 100. Moreover, as it is anticipated that for combat/tactical hardness all of the depicted components from the switches to the power supplies to the photon emitters are described in a manner that leads to a conclusion that those components are in wired communication with one another, this disclosure should not be read to preclude wireless communication, for example between the switches and the photon emitters that the switches are intended to activate. Such wireless communications may be by RF radio signal, optical interfaces, NFC devices and other wireless communicating devices according to RF, Wi-Fi, WiGig and other like communications protocols. In other words, no specific configuration as a strictly wired integral unit is to be implied by the depiction in FIGS. 1-5.

Embodiments within the scope of this disclosure may also include methods for uniquely employing the exemplary improved illuminator device 100, as discussed in general above.

Although the above description may contain specific details, these details should be construed as illustrative and not construed as limiting the disclosure in any way.

Other configurations of the described embodiments may be part of the scope of the disclosed embodiments. For example, the principles of the disclosed embodiments may be applied to each individual user or operator where each user or operator may individually employ a different configuration of an improved illuminator device 100, as needed. This enables each user or operator to make use of the benefits of the disclosed embodiments even if any one of a large number of possible applications do not need all of the described features or functionalities. In other words, there may be multiple instances of the disclosed systems and schemes each being separately employed in various possible ways at the same time where the actions of one user or operator, or even a particular configuration of a device 100 employed by one user or operator in a configuration of the photon emitters 115, 117, may not affect the actions of other users or operators using separate and discrete embodiments.

The above-described exemplary systems and methods reference certain conventional components to provide a brief, general description of suitable operating and employment scenarios in which the subject matter of this disclosure may be particularly well suited for familiarity and ease of understanding.

Those skilled in the art will appreciate that other embodiments of the disclosed subject matter may be practiced in myriad configurations for carrying into effect the disclosed object or target illumination, identification and engagement schemes with embodiments of the disclosed device as particularly depicted and described.

We claim:

1. An illuminator device, comprising:
a main housing body;
a plurality of photon emitters mounted at least one of on or in the main housing body;
at least one power source within the main body housing, the at least one power source being configured to provide electrical power to at least one of the plurality of photon emitters; and
control components configured to control one or more of the plurality of photon emitters,
wherein the main body housing has a centerline that is configured to align with a center bore axis of a weapon to which the illuminator is mounted.

2. The illuminator device of claim 1, wherein the control components are in a form of tactile activation buttons.

3. The illuminator device of claim 2, wherein the tactile activation buttons are configured to individually turn on and off each of the one or more of the plurality of photon emitters.

4. The illuminator device of claim 2, wherein the tactile activation buttons are configured to individually adjust an intensity of emissions from each of the one or more of the plurality of photon emitters.

5. The illuminator device of claim 2, wherein the tactile activation buttons are each placed at a different height with respect to the main housing body.

6. The illuminator device of claim 1, wherein the tactile activation buttons are positioned on the main body housing to facilitate ambidextrous activation of the one or more of the plurality of photon emitters.

7. The illuminator device of claim 1, wherein a first photon emitter and a second photon emitter of the plurality of photon emitters are arranged symmetrically with respect to, and parallel to, the centerline of the main housing body.

8. The illuminator device of claim 7, wherein at least one of the first photon emitter and the second photon emitter is configured to emit high intensity light in a visible light spectrum.

9. The illuminator device of claim 7, wherein at least one of the first photon emitter and the second photon emitter is configured to emit photon energy in an infrared spectrum.

10. The illuminator device of claim 7, wherein at least one of the first photon emitter and the second photon emitter is configured to emit photon energy in an ultraviolet spectrum.

11. The illuminator device of claim 7, wherein at least one of the first photon emitter and the second photon emitter is configured with at least one insert to modify photon emissions from the at least one of the first photon emitter and the second photon emitter.

12. The illuminator device of claim 11, wherein the at least one insert is at least one of a lens, a filter, a cover, a collimators, and a reflector.

13. The illuminator device of claim 1, wherein a third photon emitter of the plurality of photon emitters is arranged on, and parallel with, the centerline of the main housing body.

14. The illuminator device of claim 13, wherein the third photon emitter is configured to emit laser energy in a form of a laser beam.

15. The illuminator device of claim 14, wherein adjustment mechanisms are provided on the main housing body to adjust the laser beam in two independent planes with respect to the centerline of the main housing body.

16. The illuminator device of claim 1, wherein the main housing body comprises a mounting accessory for mounting the illuminator device on a weapon.

17. The illuminator device of claim 1, wherein the at least one power source is one or more batteries housed internally within through tunnels in the main housing body.

18. The illuminator device of claim 1, wherein the main body housing is formed of an electrically-conductive material

19. The illuminator device of claim 1, wherein the main body housing is formed by a subtractive material manufacturing process.

20. The illuminator device of claim 1, wherein the main body housing is formed by an additive material manufacturing process.
